(19) United States
(12) Patent Application Publication
(10) Pub. No.: US 2020/0058426 A1
(43) Pub. Date: Feb. 20, 2020

(54) MAGNETIC INSTALLATION BASE

(71) Applicant: FATRI UNITED TESTING & CONTROL (QUANZHOU) TECHNOLOGIES CO., LTD., Quanzhou City (CN)

(72) Inventors: Yongzhong Nie, Quanzhou City (CN); Chuan Nie, Quanzhou City (CN); Jianqing Chen, Quanzhou City (CN)

(21) Appl. No.: 16/609,785

(22) PCT Filed: May 10, 2018
(86) PCT No.: PCT/CN2018/086267

§ 371 Date: Oct. 31, 2019

(30) Foreign Application Priority Data
Apr. 24, 2018 (CN) 201810373791.0

(51) Int. Cl. H01F 7/02; G01H 11/08; H02N 15/00; H01F 1/057

(52) U.S. Cl. CPC H01F 7/0236; H01F 1/057; H02N 15/00; G01H 11/08

(57) ABSTRACT

A magnetic installation base provided by the present invention comprises: a base applicable to be connected with an acceleration sensor; and a magnet set installed on the base and having an adsorption surface formed at an end far away from the base. The magnet set comprises several magnets, and the ends of adjacent magnets forming the adsorption surface have opposite polarities. During use, the magnetic installation base is adsorbed onto the surface of a to-be-tested object, therefore, the appearance of the to-be-tested object does not need to be destroyed, moreover, since the ends of adjacent magnets forming the adsorption surface have opposite polarities, the adsorption surface is ensured to have sufficient magnetic lines, and the adsorption capacity is larger.

### TECHNICAL FIELD

The present invention relates to the technical field of installation of an acceleration sensor, and in particular to a magnetic installation base.

### BACKGROUND ART

Sensors can be mainly installed in four ways: installed via a screw, installed via a magnetic installation base, bonded via adhesive, and installed via a probe. High frequency is influenced by each of the installation manners. Installation via a screw has a widest frequency response range, and is the most safe and reliable manner in the four installation manners. The high frequency response range is reduced in the other three installation manners. Through an installation medium (for example, a magnetic installation base, a probe or adhesive) which is inserted between a sensor and an installation surface, an installation resonance frequency is thus generated, and this installation resonance frequency is smaller than an inherent frequency of the sensor, thereby reducing the high frequency range. The farther the sensor is away from a test point, the lower the installation resonance frequency is, and the lower the available frequency range is.

The magnetic installation base uses efficient and rapid installation connecting pieces which are constituted by a strong magnetic core and a stainless steel base, and is mainly applicable to installation test of vibration impact acceleration sensors. The magnetic installation base can be directly installed on a vibration part of industrial facilities, and will not destroy the appearance of facilities. According to external dimension and core material of the magnetic base, the magnetic force can be in a range of 6-25 kg.

As to the magnetic installation base in the prior art, a permanent magnet is usually installed in a stainless steel base, and during use, the magnetic installation base is directly adsorbed onto the surface of a structure of which the acceleration needs to be tested, however, due to the limitation of core materials, the adsorption capacity is limited, and when the vibration frequency is large, the magnetic installation base may drop off from the to-be-tested structure, so normal test cannot be conducted.

### SUMMARY OF THE INVENTION

Therefore, the technical problem to be solved in the present invention is to overcome the defect of small magnetic adsorption of a magnetic installation base in the prior art, so as to provide a magnetic installation base with great magnetic adsorption.

In order to solve the above technical problem, the present invention provides a magnetic installation base. The magnetic installation base includes:

a base, applicable to be connected with an acceleration sensor; and

a magnet set, installed on the base and having an adsorption surface formed at an end far away from the base, wherein the magnet set includes several magnets, and the ends of adjacent magnets forming the adsorption surface have opposite polarities.

The base is made of magnetic conductive materials, the base is internally molded with an installation chamber, and the magnet set is installed in the installation chamber via adsorption.

A connecting hole which is applicable to be connected with the acceleration sensor is molded on the base.

The installation chamber is of a cylindrical shape, the magnet set includes a circular magnet and a cylindrical magnet which is installed in the circular magnet, and magnetic poles at a lower end of the circular magnet and of the cylindrical magnet have opposite polarities.

A gap is formed between the circular magnet and the cylindrical magnet, and the gap is filled with gel.

An inner surface of the circular magnet is provided with first strengthening structures which are configured to reinforce connection strength between the circular magnet and the cylindrical magnet.

The first strengthening structures are grooves and bulges which are arranged continuously on the inner surface of the circular magnet.

An outer surface of the cylindrical magnet is provided with second strengthening structures which are configured to reinforce connection strength between the circular magnet and the cylindrical magnet

The second strengthening structures are grooves and bulges which are arranged continuously on the outer surface of the cylindrical magnet.

The magnetic installation base further includes a magnet protection structure which is arranged on the adsorption surface of the magnet set.

The magnet protection structure includes a circular magnetic conductive sheet matched with the adsorption surface of the circular magnet and a rounded magnetic conductive sheet matched with the adsorption surface of the cylindrical magnet.

The circular magnetic conductive sheet and the rounded magnetic conductive sheet are processed through double-sided grinding.

The circular magnet and the cylindrical magnet adopt a neodymium-iron-boron material.

The technical solutions of the present invention have the following advantages:

1. As to the magnetic installation base provided by the present invention, a magnet set is installed on a base, an adsorption surface is formed at an end, far away from the base, of the magnet set, the magnet set includes several magnets, and the ends of adjacent magnets forming the adsorption surface have opposite polarities. During use, the magnetic installation base is adsorbed onto the surface of a to-be-tested object, therefore, the appearance of the to-be-tested object does not need to be destroyed, moreover, since the ends of adjacent magnets forming the adsorption surface have opposite polarities, the adsorption surface is ensured to have sufficient magnetic lines, and the adsorption capacity is larger.

2. As to the magnetic installation base provided by the present invention, the base is made of magnetic conductive materials, the base is internally molded with an installation chamber, and the magnet set is installed in the installation chamber via adsorption, therefore, the installation of the magnet set is convenient.

3. As to the magnetic installation base provided by the present invention, the installation chamber is of a cylindrical shape, the magnet set includes a circular magnet and a cylindrical magnet which is installed in the circular magnet, and magnetic poles at a lower end of the circular magnet and of the cylindrical magnet have opposite polarities, and such a setting enables the magnetic lines of the adsorption surface to cover the whole adsorption surface, the quantity of magnetic lines is sufficient and the adsorption capacity is large.

4. As to the magnetic installation base provided by the present invention, a gap is formed between the circular magnet and the cylindrical magnet, and the gap is filled with gel, thereby ensuring connection strength between the circular magnet and the cylindrical magnet.

5. As to the magnetic installation base provided by the present invention, the first strengthening structures are grooves and bulges which are arranged continuously on the inner surface of the circular magnet, and when gel is filled, the gel enters the grooves, thereby reinforcing connection strength between the circular magnet and the cylindrical magnet.

6. As to the magnetic installation base provided by the present invention, the second strengthening structures are grooves and bulges which are arranged continuously on the outer surface of the cylindrical magnet, and when gel is filled, the gel enters the grooves on the outer surface of the cylindrical magnet, thereby further reinforcing connection strength between the circular magnet and the cylindrical magnet.

7. The magnetic installation base provided by the present invention further includes a magnet protection structure which is arranged on the adsorption surface of the magnet set, and the magnet protection structure can protect the magnet from being damaged, thereby ensuring magnetism of the magnet.

8. As to the magnetic installation base provided by the present invention, the circular magnetic conductive sheet and the rounded magnetic conductive sheet are processed through double-sided grinding, then optimal planeness and parallelism can be ensured, such that the connecting surface between the installation base and the to-be-tested object is flat enough, and an optimal installation resonance can be obtained.

9. As to the magnetic installation base provided by the present invention, the circular magnet and the cylindrical magnet adopt a neodymium-iron-boron material, thereby having stronger magnetism and greater adsorption capacity.

### BRIEF DESCRIPTION OF THE DRAWINGS

In order to more clearly describe specific embodiments of the present invention or technical solutions in the prior art, a brief introduction will be given below on the accompanying drawings which need to be used in the description of specific embodiments or in the prior art. Apparently, the accompanying drawings described below are some embodiments of the present invention, and for those skilled in the art, other drawings can be obtained based on these drawings without any creative effort.

FIG. 1 is a structural schematic diagram of a magnetic installation base provided by a first embodiment of the present invention;

FIG. 2 is a sectional view of a magnetic installation base as shown in FIG. 1;

FIG. 3 is a structural schematic diagram of a base of a magnetic installation base as shown in FIG. 1;

FIG. 4 is a structural schematic diagram of a cylindrical magnet of a magnetic installation base as shown in FIG. 1;

FIG. 5 is a structural schematic diagram of a circular magnet of a magnetic installation base as shown in FIG. 1;

FIG. 6 is a structural schematic diagram of a circular magnetic conductive sheet of a magnetic installation base as shown in FIG. 1;

FIG. 7 is a structural schematic diagram of a rounded magnetic conductive sheet of a magnetic installation base as shown in FIG. 1.

### REFERENCE NUMERALS

1-base;

2-connecting hole;

3-circular magnet;

4-cylindrical magnet;

5-circular magnetic conductive sheet;

6-rounded magnetic conductive sheet.

### DETAILED DESCRIPTION OF THE EMBODIMENTS

A clear and complete description will be given below on the technical solutions of the present invention in combination with the accompanying drawings. Apparently, the described embodiments are merely a part, but not all, of the embodiments of the present invention. Based on the embodiments in the present invention, all the other embodiments obtained by those skilled in the art without any creative effort shall all fall within the protection scope of the present invention.

In the description of the present invention, it should be noted that, the directional or positional relationship indicated by such terms as “center” “upper”, “lower”, “left”, “right”, “vertical”, “horizontal”, “inner” and “outer” is the directional or positional relationship shown based on the drawings, which is merely for convenient and simplified description of the present invention, rather than indicating or implying that the referred device or element must have the specific direction or must be constructed and operated in the specific direction, therefore, it cannot be understood as a limitation to the present invention. In addition, such terms as “first”, “second” and “third” are merely for the purpose of description, rather than being understood as indicating or implying relative importance.

In the description of the present invention, it should be noted that, unless otherwise definitely prescribed and defined, the terms “installation”, “connection”, “connected” and the like should be understood in its broad sense. For example, the “connection” may be a fixed connection, may also be a detachable connection or an integrated connection; may be a mechanical connection, may also be an electrical connection; and the “connected” may be directly connected and can also be indirectly connected through an intermediate medium, and can also be the internal communication inside two elements. The specific meaning of the above-mentioned terms in the present invention may be understood by those of ordinary skill in the art in light of specific circumstances.

In addition, the technical solutions in different embodiments of the present invention described below can be combined with each other as long as the technical solutions do not constitute a conflict.

### Embodiment 1

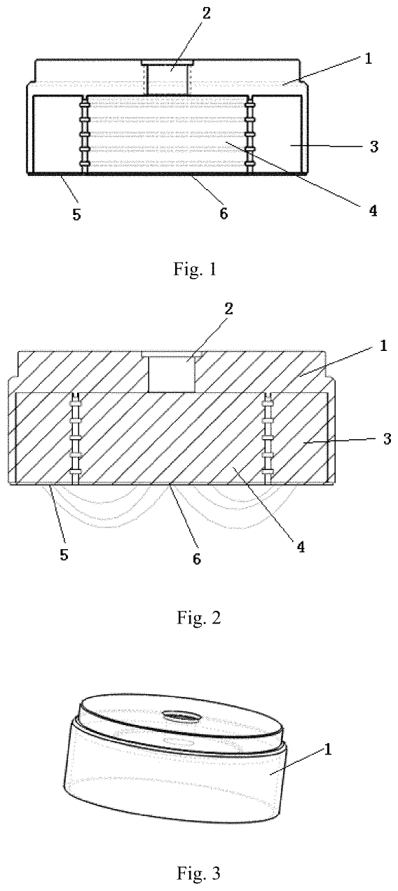

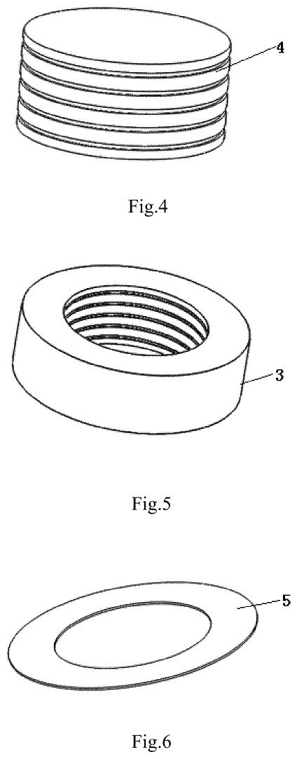

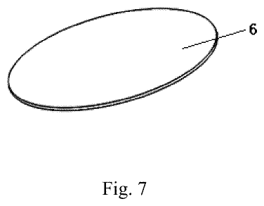

FIGS. 1-7 show one specific embodiment of a magnetic installation base. The magnetic installation base includes a base 1, wherein the base 1 is made of magnetic conductive materials, the base 1 is internally molded with an installation chamber, and a connecting hole 2 which is applicable to be connected with the acceleration sensor is molded on the base 1. The magnet set is installed in the installation chamber via adsorption, the magnet set includes a circular magnet 3 which adopts a neodymium-iron-boron material and a cylindrical magnet 4 which is installed in the circular magnet 3 and which adopts a neodymium-iron-boron material, and magnetic poles at a lower end of the circular magnet 3 and of the cylindrical magnet 4 have opposite polarities. An inner surface of the circular magnet 3 is continuously provided with grooves and bulges which serve as first strengthening structures configured to reinforce connection strength between the circular magnet 3 and the cylindrical magnet 4. An outer surface of the cylindrical magnet 4 is continuously provided with grooves and bulges which serve as second strengthening structures configured to reinforce connection strength between the circular magnet 3 and the cylindrical magnet 4. A gap is formed between the circular magnet 3 and the cylindrical magnet 4, and the gap is filled with gel, in this way, the gel enters grooves of the outer surface of the cylindrical magnet 4 and grooves of the inner surface of the circular magnet 3, respectively, thereby strengthening connection strength between the circular magnet 3 and the cylindrical magnet 4. The lower end of the cylindrical magnet 4 is provided, in a matching manner, with a rounded magnetic conductive sheet 6 which adopts a process of double-sided grinding, the lower end of the circular magnet 3 is provided, in a matching manner, with a circular magnetic conductive sheet 5 which adopts a process of double-sided grinding, and the rounded magnetic conductive sheet 6 and the circular magnetic conductive sheet 5 form a magnet protection structure which protects the magnet from being damaged.

During use, the acceleration sensor is connected within the connecting hole 2 on the base 1 via a bolt, such that the acceleration sensor is fixedly connected with the base 1, then the magnetic installation base is adsorbed onto the surface of a to-be-tested object, therefore, the surface structure of the to-be-tested object does not need to be destroyed. The magnetic installation base has a stronger adsorption capacity, and tests prove that the adsorption capacity can reach 580 N. When under vibration, the to-be-tested object will vibrate along with the acceleration sensor, and a piezoelectric element inside the acceleration sensor will generate electric signals and then output the electric signals.

In a substitutable embodiment, the base 1 adopts non-magnetic conductive materials, and the magnet set is fixed on the base 1 via a fastening piece.

In a substitutable embodiment, the magnet protection structure is an overall rounded magnetic conductive structure.

In a substitutable embodiment, the installation chamber inside the base 1 is rectangular, the magnet set includes three bar magnets, and the ends of adjacent magnets forming the adsorption surface have opposite polarities.

Apparently, the above embodiments are merely examples given for the purpose of clear description, rather than for limiting the embodiments. For those skilled in the art, other various variations or modifications can be made on the basis of the above description. There's no need and also no possibility to enumerate all the embodiments herein, while the apparent variations or modifications derived herein shall still fall within the protection scope of the present invention.

1. A magnetic installation base, comprising:
a base, applicable to be connected with an acceleration sensor; and
a magnet set, installed on the base and having an adsorption surface formed at an end far away from the base, wherein the magnet set comprises several magnets, and the ends of adjacent magnets forming the adsorption surface have opposite polarities.

2. The magnetic installation base of claim 1, wherein
the base is made of magnetic conductive materials, the base is internally molded with an installation chamber, and the magnet set is installed in the installation chamber via adsorption.

3. The magnetic installation base of claim 1, wherein a connecting hole which is applicable to be connected with the acceleration sensor is molded on the base.

4. The magnetic installation base of claim 2, wherein the installation chamber is of a cylindrical shape, the magnet set comprises a circular magnet and a cylindrical magnet which is installed in the circular magnet, and magnetic poles at a lower end of the circular magnet and of the cylindrical magnet have opposite polarities.

5. The magnetic installation base of claim 4, wherein a gap is formed between the circular magnet and the cylindrical magnet, and the gap is filled with gel.

6. The magnetic installation base of claim 5, wherein an inner surface of the circular magnet is provided with first strengthening structures which are configured to reinforce connection strength between the circular magnet and the cylindrical magnet.

7. The magnetic installation base of claim 6, wherein the first strengthening structures are grooves and bulges which are arranged continuously on the inner surface of the circular magnet.

8. The magnetic installation base of claim 6, wherein an outer surface of the cylindrical magnet is provided with second strengthening structures which are configured to reinforce connection strength between the circular magnet and the cylindrical magnet.

9. The magnetic installation base of claim 8, wherein the second strengthening structures are grooves and bulges which are arranged continuously on the outer surface of the cylindrical magnet.

10. The magnetic installation base of claim 9, further comprising a magnet protection structure which is arranged on the adsorption surface of the magnet set.

11. The magnetic installation base of claim 10, wherein the magnet protection structure comprises a circular magnetic conductive sheet matched with the adsorption surface of the circular magnet and a rounded magnetic conductive sheet matched with the adsorption surface of the cylindrical magnet.

12. The magnetic installation base of claim 11, wherein the circular magnetic conductive sheet and the rounded magnetic conductive sheet are processed through double-sided grinding.

13. The magnetic installation base of claim 4, wherein the circular magnet and the cylindrical magnet adopt a neodymium-iron-boron material.

14. The magnetic installation base of claim 7, wherein an outer surface of the cylindrical magnet is provided with second strengthening structures which are configured to reinforce connection strength between the circular magnet and the cylindrical magnet.

15. The magnetic installation base of claim 5, wherein the circular magnet and the cylindrical magnet adopt a neodymium-iron-boron material.

16. The magnetic installation base of claim 6, wherein the circular magnet and the cylindrical magnet adopt a neodymium-iron-boron material.

17. The magnetic installation base of claim 7, wherein the circular magnet and the cylindrical magnet adopt a neodymium-iron-boron material.

18. The magnetic installation base of claim 9, wherein the circular magnet and the cylindrical magnet adopt a neodymium-iron-boron material.

19. The magnetic installation base of claim 10, wherein the circular magnet and the cylindrical magnet adopt a neodymium-iron-boron material.

20. The magnetic installation base of claim 11, wherein the circular magnet and the cylindrical magnet adopt a neodymium-iron-boron material.
